(19) United States
(12) Patent Application Publication
(10) Pub. No.: US 2015/0058107 A1
(43) Pub. Date: Feb. 26, 2015

(54) Computer Implemented System and Method for Managing Vendor Offers Having a Donation Component

(71) Applicant: Dharmesh Thakkar, Waterloo (CA)

(72) Inventor: Dharmesh Thakkar, Waterloo (CA)

(73) Assignee: SPIRALTEK INC., Waterloo, ON (CA)

(21) Appl. No.: 14/464,242

(22) Filed: Aug. 20, 2014

Related U.S. Application Data
(60) Provisional application No. 61/868,085, filed on Aug. 20, 2013.

(51) Int. Cl. G06Q 30/02

(52) U.S. Cl. CPC G06Q 30/0279; G06Q 30/0222
USPC 705/14.23

(57) ABSTRACT

There is disclosed a computer-implemented system and method for managing vendor offers to interested buyers via a central hub server which develops and deploys multiple intermediary websites or mobile apps for various participating public engagement organizations. The central hub server stores a list of offers from multiple vendors, and makes that list of vendor offers available to prospective buyers or patrons via the multiple intermediary websites, web plugins, or mobile apps, configured on behalf of the public engagement organizations. In a preferred embodiment, the websites or mobile apps configured for multiple third parties comprise customized skins, and may also include unique display fields and/or entry fields which allow each participating public engagement organization to offer a filtered subset of vendor offers, which may be organized and presented in a customized way for each custom website, web plugin, or mobile app.

### FIELD OF THE INVENTION

The present invention relates generally to the field of electronic commerce, and more particularly to computer-implemented systems and methods for managing vendor offers for products and services that have a donation component.

### BACKGROUND

Traditionally, retailers have used discount coupons and rebate offers to promote their products and services to prospective buyers through conventional methods, such as direct mail flyers and newspapers. However, these conventional methods may increasingly be ineffective, as they may broadly target buyers that do not want or need the particular products or services, and these flyers and newspapers may often end up straight in the recycling box without being opened.

More recently, vendors have tried offering products or services in a more targeted way by participating in electronic commerce, for example by offering discount certificates through group deal websites where visitors can select offers of interest. Many group deal websites may have a tipping point, for example, a minimum number of sales of certain goods or services that need to be reached for the offer to execute. The premise with such deep discounting through group deal websites is that the vendor gets many new buyers that will be repeat buyers at regular price in future. However, that premise often doesn't hold, as the active users of such group deal websites often tend to be price-sensitive people who are in search of the best deal they can find. Consequently, group deal buyers may not be likely to turn into repeat buyers, and vendors often lose money on such deeply discounted products or services.

Therefore, what is needed are improved systems and methods for vendors offering their goods or services more effectively to buyers, particularly via electronic commerce and via computer-implemented systems and methods.

### SUMMARY

The present invention relates to a computer-implemented system and method for managing vendor offers to interested buyers via a central hub server which hosts multiple intermediary websites or mobile apps for various participating intermediary public engagement entities. The central hub server may collect and store a list of offers from multiple vendors, and make that list of vendor offers available to prospective buyers or patrons via the multiple intermediary websites, web plug-ins, or mobile apps, configured on behalf of the public engagement entities.

In a preferred embodiment, the websites or mobile apps have skins which are customized for each participating intermediary entity, and may also include unique display fields and/or entry fields which allow each participating public engagement organization to offer a full listing of vendor offers or a filtered subset of vendor offers, which may be further organized and presented in a customized way for each custom website, web plug-in, or mobile app.

As an illustrative example, the participating public engagement entities may have a charitable or non-profit purpose. These organizations may include, for example, registered charities, schools, hospitals, public broadcasting, community groups and faith groups, and other similar types of non-profit organizations that may regularly, or from time-to-time, seek sponsorship or funding from the public and various prospective corporate donors.

In a preferred embodiment, each vendor offer includes a donation component which promises a donation of at least a part of the proceeds of a completed purchase and sale transaction for a charitable, non-profit, or fundraising purpose. However, this donation component need not be specific to a particular charitable entity. Rather, the vendor may limit the offer of the donation component to a few, many or all of the participating intermediary public engagement entities for which customized website shells or mobile app screens have been developed.

Similarly, in another embodiment, as each participating intermediary public engagement entity selects a vendor offer to promote, the customized website or web app for the vendor may be automatically updated to show the new intermediary public engagement entity as a charitable or non-profit organization that the vendor is supporting.

By having a listing of vendor offers and a listing of participating intermediary public engagement entities cross-referencing each other, exposure to the public for both vendors and participating entities is significantly enhanced.

In another embodiment, upon acceptance of a vendor's offer by a buyer, the system issues a certificate, which the buyer can redeem for the product or service.

Alternatively, upon acceptance of a vendor's offer by a buyer, a product may be shipped to the buyer. Therefore, the participating entity can immediately receive the donation portion, while the vendor receives the balance less a processing fee.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present invention will be better understood and objects of the invention will become apparent when consideration is given to the following detailed description thereof. Such description makes reference to the annexed drawings wherein:

FIGS. 1A and 1B show schematic block diagrams of a system architecture in accordance with an illustrative embodiment;

FIG. 2 shows a schematic flow chart of a method in accordance with an illustrative embodiment;

FIG. 3 shows an illustrative screen layout of a customized website skin as established for a participating intermediary public engagement entity;

FIG. 4 shows an illustrative screen of a mobile communication device having a customized layout for a participating intermediary public engagement entity; and

FIG. 5 shows a schematic block diagram of a generic computing device in accordance with an illustrative embodiment.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present invention relates to a computer-implemented system and method for managing multiple vendor offers to interested buyers via a central hub server which hosts multiple intermediary websites and mobile apps for various participating intermediary public engagement entities.

The websites or mobile apps have skins, which are customized for each participating intermediary entity. These skins may also include unique display fields and/or entry fields which allow each participating public engagement organization to offer a full listing of vendor offers or a filtered subset of vendor offers, which may be further organized and presented in a customized way for each custom website, web plug-in, or mobile app.

In an embodiment, the participating public engagement entities may have a charitable or non-profit purpose. These organizations may include, for example, registered charities, schools, hospitals, public broadcasting, community groups and faith groups, and other similar types of non-profit organizations that may regularly, or from time-to-time, seek sponsorship or funding from the public and various prospective corporate donors.

The donation component may be negotiated to originate from the vendor, or alternatively by the entity running the central hub server and corresponding system within certain predetermined ranges and frequency.

Alternatively, a donation component may be added onto to a deal price and be borne by the buyer who accepts the deal. Such deals with discounted prices and a designated donation may be presented to buyers at multiple online locations.

This may include, for example, mobile apps and websites hosted by the central hub server, or alternatively via other mobile apps and websites hosted by one of the participating non-profit entities that are running a fundraising campaign, for example. In this case, the vendor offers may be presented as additional or alternative ways in which visitors to their campaign website can participate, if a larger cash donation is not possible. Such a deal may also be presented as a custom “call to action” for the patrons of the particular non-profit, fundraising event, or fundraising campaign.

In an embodiment, when a deal is purchased by the buyer through the mobile app or website of the non-profit entity, the buyer receives a certificate to get the product or service, the vendor receives a payment, and the non-profit receives the designated donation, even before the buyer uses the certificate.

Thus, the present system and method provides vendors with an effective way of building goodwill in the local community, as the buyer/patron appreciates that their favored non-profit received the designated donation.

In an embodiment, the system and method tracks a buyer's purchases and calculates the total amount of donations that the buyer has enabled through his/her purchases. This may encourage the buyer to buy more vendor services to increase their support for their charity or non-profit.

The system and method also provides the buyer with a “feel-good” incentive to distribute the information about the deals, as each deal ties in a designated donation amount to the non-profit. For this purpose, in an embodiment, the system and method enables the buyer to electronically communicate the deal to contacts in their social network who may also be interested in the deal. When a contact receives news about the deal, they can click on a link to visit a website or to download a mobile app to allow them to make a purchase. This brings in more traffic and new people to mobile apps and website of participating nonprofits.

A vendor may be invited to participate by offering some of its goods or services at a discount, or may apply to offer their goods and services via the system and method. The vendor may be any individual or organization that provides goods or services to a buyer, and may be local, national, or global. The vendor may even be the same entity operating the present system.

Once the vendor's good or services are identified for a discount offering, the terms of the offer are determined. This may include a discount rate and a designated donation to the non-profit of the patron's choice through which the deal is presented. The offer may be structured to be a pre-paid offer or a post-paid offer. For pre-paid offers, patrons make the payment at the offer presentation location. For post-paid offers, patrons make the payment at the vendor's location at the time of receiving the offered product or service.

In an embodiment, the system and method is enabled through the internet and via mobile communication networks, mobile apps and websites of non-profit organizations and/or vendors. A non-profit organization could be provided with some control over what kind of and how many deals show up in its mobile app and website. For example, a non-profit focused on promoting nutritious food may not want too many discount offers from burger and pizza vendors.

Buyer participation is received in the form of buying the deal if it is a pre-paid deal, or redeeming the deal if the deal is structured for payment at vendor location. Each buyer that purchases a pre-paid offer is charged using their method of payment. The buyer is then provided with a receipt of purchase, such as an email, coupon, gift certificate, etc. that can be printed out for redemption for the stipulated product or service with the vendor. Each buyer that redeems a post-paid offer is provided with a coupon code or a special web link that can be used by the buyer to obtain the stipulated product or service by making the payment with the brick-and-mortar or online vendor.

Once a pre-paid deal is purchased, the vendor receives a payment based on the previous agreement for a portion of the sale of the discounted goods or services, after taking out cost charged by the operator of the system of platform and the designated donation to the nonprofits through whose mobile apps and websites the deals were sold. Once a post-paid deal is redeemed, the vendor is billed by the operator of the system for the designated donation and a stipulated processing fee.

The buyer can then take the printed receipt of pre-paid purchase (or other indication of purchase) to the vendor, who will provide the goods or services purchased. In case of post-paid deals, buyer can present the coupon code or click on a special web link to redeem the offer and receive the product or service by making the payment to the vendor. Necessary information of the buyers that accepted the offer, e.g. name, email address, phone number, and shipping address may also be transmitted to vendor for delivery of the goods or services.

In an alternative embodiment of the present invention, a points program may also be offered. The points are awarded to buyers based on their ongoing deal participation. The points may be earned by various actions of the buyer, e.g. based on the amount of donations raised through the buyer's purchases, based on number of sharing the deal information through various channels such as emails and social media, and based on the amount of donations raised through purchases by their friends. A higher point score may lead to better discount for the buyer from the vendor or a higher donation to the non-profit on a deal purchase.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

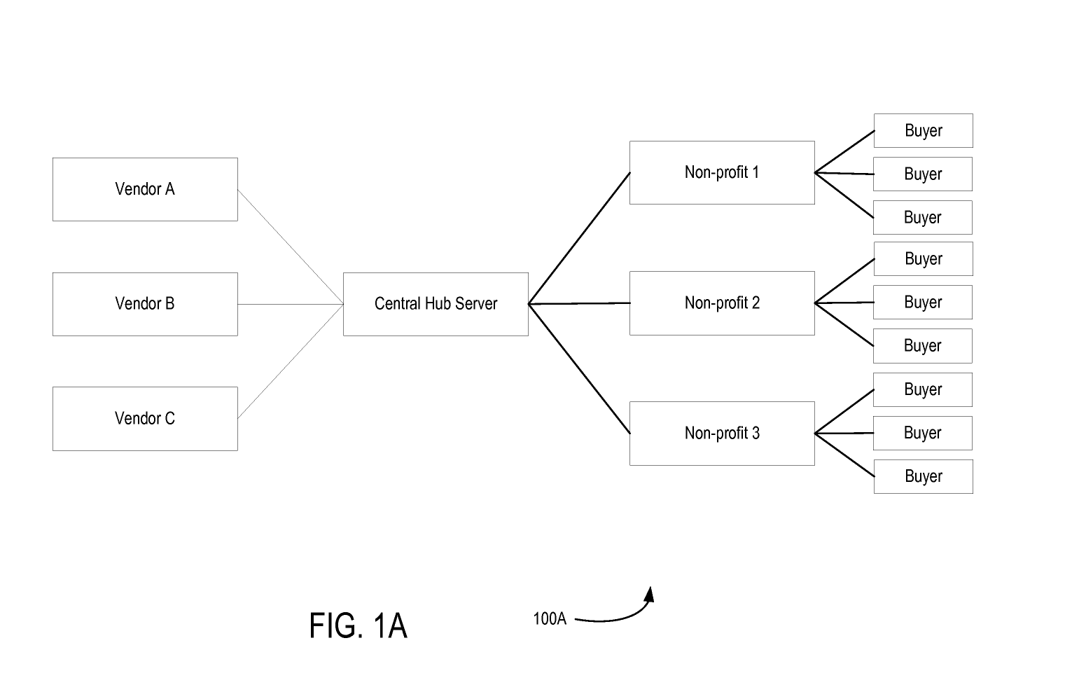

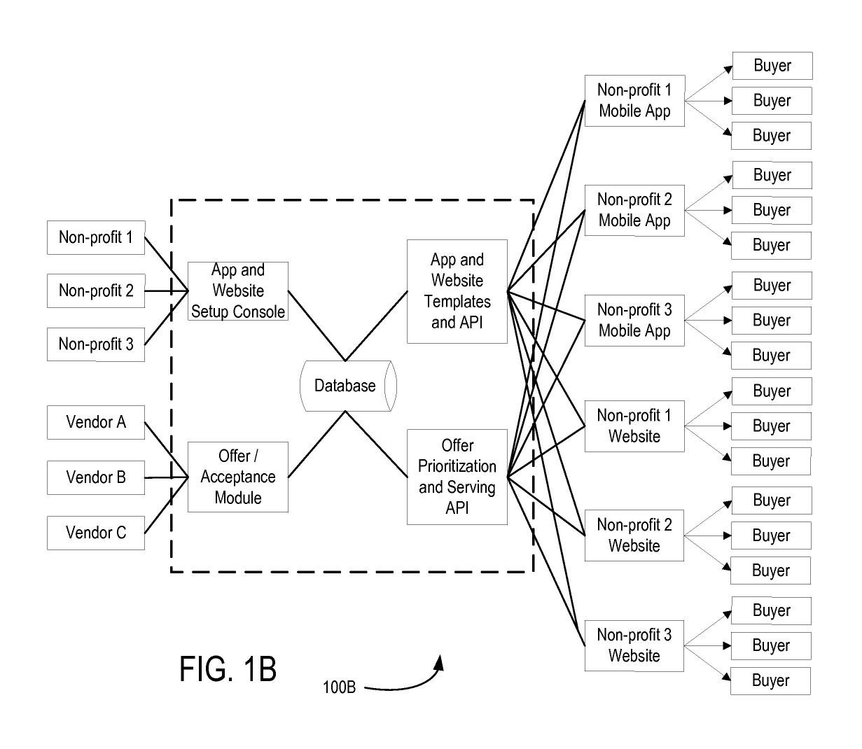

Now referring to FIGS. 1A and 1B, shown is a schematic block diagram of a system architecture in accordance with an illustrative embodiment. Starting from the left side of the figure, a list of vendors A, B and C may provide various vendor offers for sale, which are received and stored by a central hub server.

In this illustrative example, the central hub server also hosts various websites with a customized website skin, or a customized mobile app having a skin specifically for each of the participating public engagement entities, such as Non-profits 1, 2 and 3.

Each non-profit may have an established brand which allows each prospective buyer/patron to engage with their respective organization. For example, a well known community charity participating as one of the non-profit organizations may be undertaking a fundraising campaign, and may participate to include all vendor offers in order to list as many vendor offers to their respective patrons as possible.

As shown in FIG. 1B, an illustrative system architecture includes various interfaces for non-profits, vendors and buyers to interface with the system.

For example, non-profits 1, 2 and 3 can set up an account with the system via an App and Website Setup Module and initially set up their customized website or mobile app. A database stores their account information and desired preferences, generates a mobile app or website using predefined templates. APIs allow various buyers to access the system via a mobile app running on their mobile devices or tablets, or via a website on any communication device with internet access.

Still referring to FIG. 1B, similarly, vendors A, B and C can set up an account with the system via an Offer/Acceptance Module, which also interfaces with the database to store information about the vendors and their offers. An Offer Prioritization and Serving API allows the vendors' offers to be made available to prospective buyers via the mobile apps or websites.

In an embodiment, the system and method includes a member and donor engagement tool, which may be customized for a participating public engagement organization. For example, a non-profit firm may have its own customized mobile app, or a full website or a website plugin. A vendor offer comprising a discounted price for a product or service, and a designated donation from the vendor to the nonprofit is negotiated with the vendor. When a vendor's offer is accepted by a buyer, the buyer receives the product or service, the vendor's product or service gets promoted to the buyer, and the designated non-profit charity receives the designated donation.

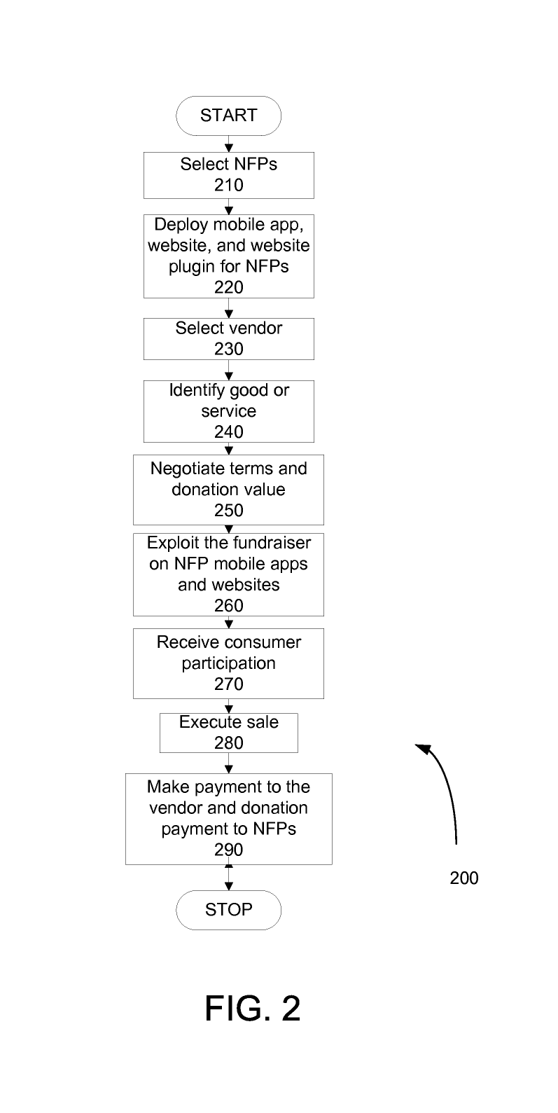

Now referring to FIG. 2, shown is a schematic flow chart of a method 200 in accordance with an illustrative embodiment. Starting at block 210, the method first selects a not-for-profit (NFP) or non-profit entity. The NFP may be solicited for the system or may hear of the system and may approach the system's provider without being solicited. The NFP may be any charity or non-profit organization that accepts donations.

A mobile app, website, or website plug-in that enables buyer participation to purchase the deal is then deployed for the selected NFPs at block 220.

At block 230, method 200 selects a vendor. The vendor may be any individual or entity that provides goods or services to a buyer. The vendor may be local, national or global in terms of the geography the vendor provides products or services, and the vendor may be solicited for the system or may hear of the system and may approach the system's provider without being solicited.

At block 240, the method 200 identifies the goods or services offered by the vendor. The good may be any product sold or distributed by the vendor, and the service likewise, can be any service provided by the vendor.

Now referring to block 250, method 200 facilitates a negotiation between Vendors, NFPs, and the system operator, such that terms and a donation value may be determined. The terms of the offer are determined and include discount to be provided, the donation amount by the business on each sale, duration of the offer, for example 24 hours, and maximum number, if any, of the good or service the vendor is willing to offer, expiration of the good or service, or restrictions associated with the good or service.

Now referring to block 260, the Vendor offers are collected, and sent to the central server to be processed for presenting to prospective buyers through mobile apps and websites of participating non-profit organizations. The mobile apps and websites display the details of each deal, including the donation amount from the vendor.

At block 270, the system waits to receive a buyer participation signal. A buyer participates by buying the offer on a participating mobile app or a website. Purchasing the offer may entail providing the name of the buyer; address of the buyer, and form of payment to purchase the offer.

At step 280 the sale of the good or service is executed by providing the buyer with a certificate.

At step 290, payment is made to the vendor and the designated donation from the sale is paid to non-profit whose mobile app or website was used to purchase the offer.

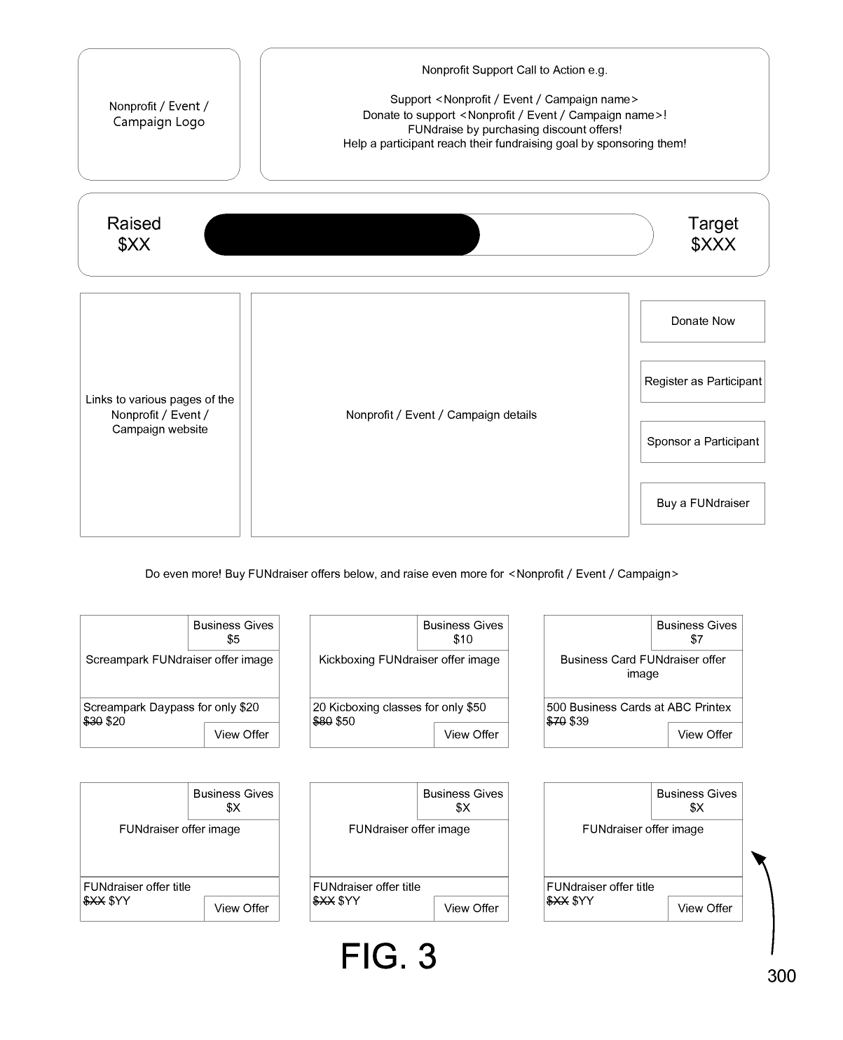

Now referring to FIG. 3, shown is an illustrative screen layout of a customized website, as established for a participating intermediary public engagement entity. As illustrated, the screen layout includes a number of different parts, one of which is a listing of various vendor offers. The vendor offers listed may be static or dynamic, and may also be scrolled to allow a partial or full listing of vendor offers being promoted. New vendor offers may be added, and expired vendor offers may be removed at any time as may be desired. If the website is set up as a fundraising website, a visitor may have the option of making a direct cash donation, or alternatively making a purchase via one or more vendor offers with the knowledge that a portion of the proceeds will be donated to their charity of choice.

Each vendor offer includes a donation component, which promises a donation of at least a part of the proceeds of a completed purchase and sale transaction for a charitable, non-profit, or fundraising purpose. As the vendor offer is presented through a particular entity's website or web app, in this case, the link to the vendor offer will be uniquely associated with the particular participating entity. However, from the vendor's perspective, this donation component need not be specific to a particular charitable entity, and the vendor's offer may be made through multiple participating entities.

In certain situations, the vendor may limit the offer of the donation component to a few entities, if the nature of the offer is geographically limited. For example, a vendor's offer may be a service delivered locally which cannot be shipped, and therefore the offer may be made only to participating entities that are geographically close. In this case, rather than waiting for a participating entity to select a vendor, the system and method may be configured to suggest certain vendor offers that may make sense for a participating entity to promote.

As each participating intermediary public engagement entity selects a vendor offer to promote via their customized website or web app, the vendor's website may also be automatically updated to show the new intermediary public engagement entity as a charitable or non-profit organization that the vendor is now supporting.

Advantageously, by having a listing of vendor offers at the intermediary public engagement entity websites or web apps, and by in turn having a regularly updated listing of intermediary public engagement entities that a vendor is supporting via their product or service offers, a vendor's goods and services receive an increasing level of exposure to the public, as do the intermediary public engagement entities themselves via exposure to the public via the vendor websites and mobile apps.

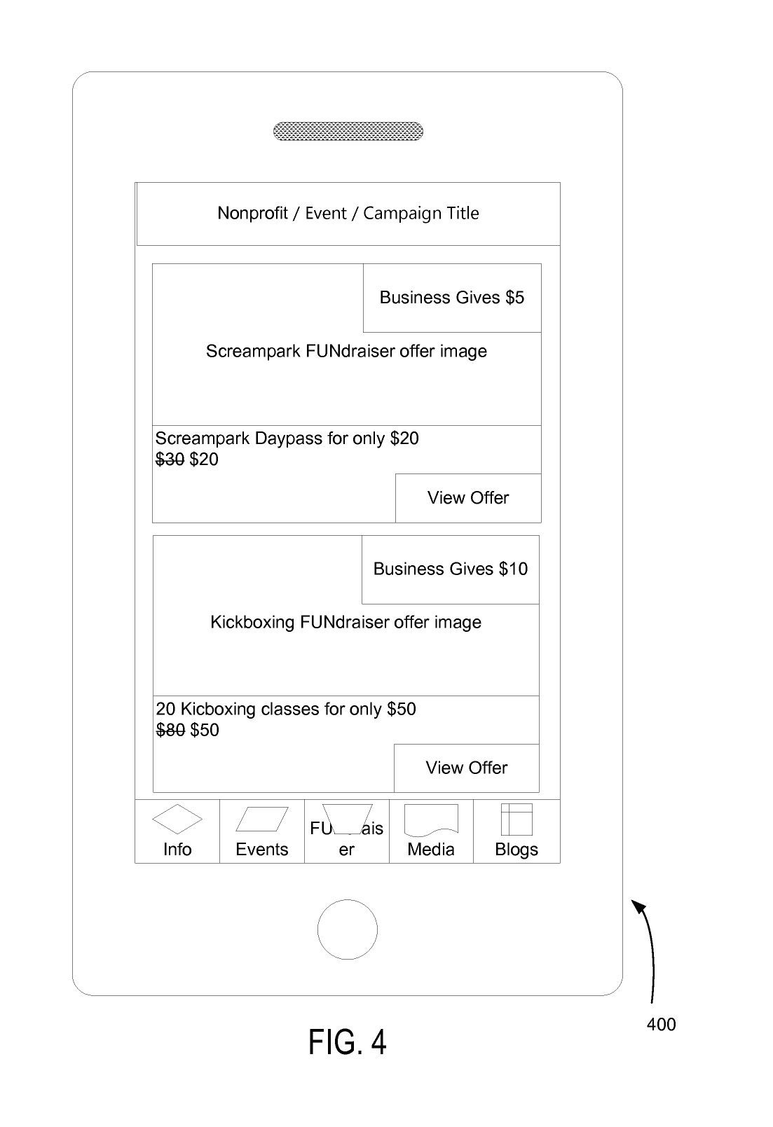

FIG. 4 shows an illustrative screen of a mobile communication device having a customized layout for a participating intermediary public engagement entity. As shown, the screen also shows a listing if vendor offers being promoted via the mobile app. Generally speaking, all features available via a web site version may be reformatted for a mobile device screen but still available and functional as described above.

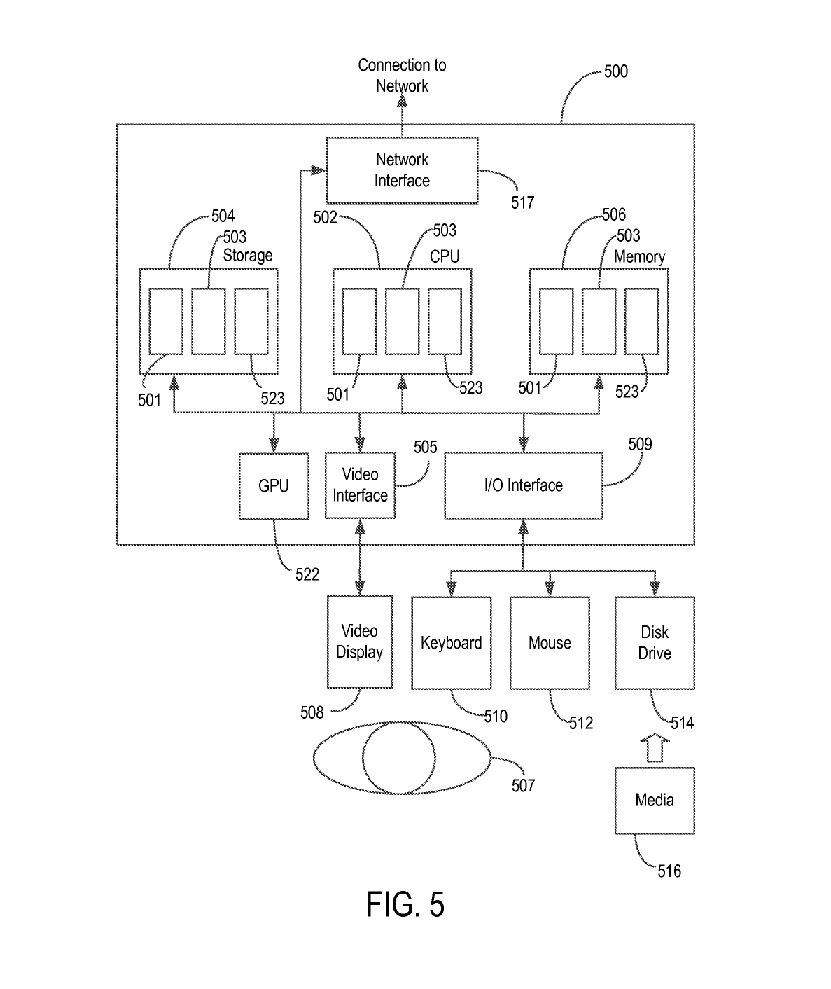

Now referring to FIG. 5, shown is a schematic block diagram of a generic computing device. A suitably configured computer device, and associated communications networks, devices, software and firmware may provide a platform for enabling one or more embodiments as described above. By way of example, FIG. 5 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run these calculations in parallel with CPU 502. An operator 505 may interact with the computer device 500 using a video display 508 connected by a video interface 505, and various input/output devices such as a keyboard 510, pointer 512, and storage 514 connected by an I/O interface 509. In known manner, the pointer 512 may be configured to control movement of a cursor or pointer icon in the video display 508, and to operate various graphical user interface

(GUI) controls appearing in the video display 508. The computer device 500 may form part of a network via a network interface 511, allowing the computer device 500 to communicate with other suitably configured data processing systems or circuits. One or more different types of sensors 530 connected via a sensor interface 532 may be used to search for and sense input from various sources. The sensors 530 may be built directly into the generic computer device 500, or optionally configured as an attachment or accessory to the generic computer device 500.

Thus, in an aspect, there is provided a system and method of discount retailing to mutually satisfy consumers, vendors, and non-profit entities. This involves first obtaining consent from non-profit entities to create free or low-cost mobile apps, websites, and website plug-ins for those non-profits, which serve to engage their donors and members, as well as display and facilitate deals exploitation. A consent is also obtained from one or more vendors to market and advertise an item normally provided by the merchant at a standard offer price. A deal comprising a discounted price for a product or service is determined, and designated donation is negotiated with the vendor.

The deals with discounted prices and a designated donation is presented to buyers in the mobile apps and websites of various nonprofits. A purchase order may be received from consumers through the mobile app or website of the participating non-profits entities. The consumer may be provided with a certificate to obtain the product or service from the vendor, providing the vendor with a payment for the goods or services, and providing the designated donation to the non-profit, even before the consumer uses the certificate.

In an embodiment, the consumer activities include buying a deal and redeeming that deal at the merchant retail or online location.

In another embodiment, the consumer activities include accepting multiple deals.

In another embodiment, the consumer activities include providing remarks after accepting a deal and redeeming said deal at the vendor.

In another embodiment, the consumer activities include communicating with other consumers about a vendor offer.

In another embodiment, the consumers receive bonus points through various actions, e.g. based on the amount of donations raised through the consumer's purchases, the number of times the deal information is shared through various channels such as emails and social media, and the amount of donations raised through purchases by their friends.

In another embodiment, a higher accumulated bonus point score may lead to a better discount for the consumer from the merchant, or a higher donation to the non-profit on a deal purchase.

In another embodiment, the consumer activities include providing remarks after accepting a vendor offer and redeeming the goods or services at the vendor.

In another embodiment, the consumer activities include communicating with other consumers about a deal.

In another embodiment, the consumers receive bonus points through various actions, e.g. based on the amount of donations raised through the consumer's purchases, number of times the deal information is shared through various channels such as emails and social media, and the amount of donations raised through purchases by their friends.

In another embodiment, a higher bonus score may lead to a better discount for the consumer from the merchant, or a higher donation to the non-profit entity on a deal purchase.

In another aspect, there is provided a method operable on a computing device having a processor and memory for managing vendor offers to buyers, comprising: receiving from a vendor input an electronic offer for goods or services targeting buyers via their devices, the offer including a donation component; establishing one or more intermediary websites or mobile apps for one or more participating intermediary entities; electronically offering the vendor's goods or services to buyers via the one or more intermediary websites or mobile apps with details of the donation component; upon electronic acceptance of an offer by a buyer, issuing to the buyer a coupon or certificate to be redeemed for the goods or services, and forwarding the donation component electronically to the one or more participating intermediary entities.

In an embodiment, the method further comprises collecting the vendor's offer for goods or services, and storing the offers electronically with offers for goods or services received from other vendors; and listing the collected offers from the vendors together on the one or more intermediary websites or mobile apps.

In another embodiment, the method further comprises customizing the one or more intermediary websites or mobile apps for each participating intermediary entity, the customization including a customized listing of the offers for goods or services from various vendors.

In another embodiment, the method further comprises filtering a subset of the vendor's offers for goods or services for display on the one or more intermediary websites or mobile apps.

In another embodiment, the method further comprises allowing a participating intermediary entity to select which vendor offers to promote on their respective one or more intermediary websites or mobile apps.

In another embodiment, the method further comprises allowing a participating vendor to select which participating intermediate entities may display their offers via the one or more intermediary websites or mobile apps, and upon selection, automatically displaying the vendor offers on the respective one or more intermediary websites or mobile apps.

In an embodiment, the method further comprises: upon selection of a vendor's offer by a participating intermediary, automatically updating the vendor's website to display the participating intermediary as a donation candidate.

In another embodiment, the addition of a new vendor or a new intermediary to participating vendors or intermediary entities is communicated, and allowing the participating intermediary entities or vendors to add the new vendors or intermediaries to their respective apps or websites.

In an embodiment, the method further comprises: electronically communicating to the buyers' devices the addition of a new vendor offer or a new participating intermediary entity; and directing the buyer to the newly added vendor offer or intermediary entity via one or more electronic links.

In another embodiment, the method further comprises enabling electronic communication of a new vendor offer from one buyer's device to another buyer's device.

In another aspect, there is provided a system operable on a computing device having a processor and memory for managing vendor offers to buyers, wherein the system is adapted to: receive from a vendor input an electronic offer for goods or services targeting buyers via their devices, the offer including a donation component; establish one or more intermediary websites or mobile apps for one or more participating intermediary entities; electronically offer the vendor's goods or services to buyers via the one or more intermediary websites or mobile apps with details of the donation component; upon electronic acceptance of an offer by a buyer, issuing to the buyer a coupon or certificate to be redeemed for the goods or services, and forwarding the donation component electronically to the one or more participating intermediary entities.

In an embodiment, the system further comprises collecting the vendor's offer for goods or services, and storing the offers electronically with offers for goods or services received from other vendors; and listing the collected offers from the vendors together on the one or more intermediary websites or mobile apps.

In another embodiment, the system is further adapted to customize the one or more intermediary websites or mobile apps for each participating intermediary entity, the customization including a customized listing of the offers for goods or services from various vendors.

In another embodiment, the system is further adapted to filter a subset of the vendor's offers for goods or services for display on the one or more intermediary websites or mobile apps.

In another embodiment, the system is further adapted to allow a participating intermediary entity to select which vendor offers to promote on their respective one or more intermediary websites or mobile apps.

In another embodiment, the system is further adapted to allow a participating vendor to select which participating intermediate entities may display their offers via the one or more intermediary websites or mobile apps, and upon selection, automatically displaying the vendor offers on the respective one or more intermediary websites or mobile apps.

In another embodiment the system further adapted to automatically update the vendor's website to display the participating intermediary as a donation candidate upon selection of a vendor's offer by a participating intermediary.

In another embodiment, the system is further adapted to communicate the addition of a new vendor or a new intermediary to participating vendors or intermediary entities, and allowing the participating intermediary entities or vendors to add the new vendors or intermediaries to their respective apps or websites.

In another embodiment, the system is further adapted to: electronically communicate to the buyers' devices the addition of a new vendor offer or a new participating intermediary entity;

and direct the buyer to the newly added vendor offer or intermediary entity via one or more electronic links.

In another embodiment, the system is further adapted to enable electronic communication of a new vendor offer from one buyer's device to another buyer's device.

While illustrative embodiments have been described above by way of example, it will be appreciated that various changes and modifications may be made without departing from the scope of the invention, which is defined by the following claims.

1. A method operable on a computing device having a processor and memory for managing vendor offers to buyers, comprising:
receiving from a vendor input an electronic offer for goods or services targeting buyers via their devices, the offer including a donation component;
establishing one or more intermediary websites or mobile apps for one or more participating intermediary entities;
electronically offering the vendor's goods or services to buyers via the one or more intermediary websites or mobile apps with details of the donation component;
upon electronic acceptance of an offer by a buyer, issuing to the buyer a coupon or certificate to be redeemed for the goods or services, and
forwarding the donation component electronically to the one or more participating intermediary entities.

2. The method of claim 1, further comprising:
collecting the vendor's offer for goods or services, and storing the offers electronically with offers for goods or services received from other vendors; and
listing the collected offers from the vendors together on the one or more intermediary websites or mobile apps.

3. The method of claim 2, further comprising:
customizing the one or more intermediary websites or mobile apps for each participating intermediary entity, the customization including a customized listing of the offers for goods or services from various vendors.

4. The method of claim 3, further comprising filtering a subset of the vendor's offers for goods or services for display on the one or more intermediary websites or mobile apps.

5. The method of claim 1, further comprising allowing a participating intermediary entity to select which vendor offers to promote on their respective one or more intermediary websites or mobile apps.

6. The method of claim 1, further comprising:
allowing a participating vendor to select which participating intermediate entities may display their offers via the one or more intermediary websites or mobile apps, and
upon selection, automatically displaying the vendor offers on the respective one or more intermediary websites or mobile apps.

7. The method of claim 5, further comprising:
upon selection of a vendor's offer by a participating intermediary, automatically updating the vendor's website to display the participating intermediary as a donation candidate.

8. The method of claim 7, further comprising:
communicating the addition of a new vendor or a new intermediary to participating vendors or intermediary entities, and allowing the participating intermediary entities or vendors to add the new vendors or intermediaries to their respective apps or websites.

9. The method of claim 8, further comprising:
electronically communicating to the buyers' devices the addition of a new vendor offer or a new participating intermediary entity; and
directing the buyer to the newly added vendor offer or intermediary entity via one or more electronic links.

10. The method of claim 9, further comprising:
enabling electronic communication of a new vendor offer from one buyer's device to another buyer's device.

11. A system operable on a computing device having a processor and memory for managing vendor offers to buyers, wherein the system is adapted to:
receive from a vendor input an electronic offer for goods or services targeting buyers via their devices, the offer including a donation component;
establish one or more intermediary websites or mobile apps for one or more participating intermediary entities;
electronically offer the vendor's goods or services to buyers via the one or more intermediary websites or mobile apps with details of the donation component;
upon electronic acceptance of an offer by a buyer, issuing to the buyer a coupon or certificate to be redeemed for the goods or services, and
forwarding the donation component electronically to the one or more participating intermediary entities.

12. The system of claim 11, further comprising:
collecting the vendor's offer for goods or services, and storing the offers electronically with offers for goods or services received from other vendors; and
listing the collected offers from the vendors together on the one or more intermediary websites or mobile apps.

13. The system of claim 2, further comprising:
customizing the one or more intermediary websites or mobile apps for each participating intermediary entity, the customization including a customized listing of the offers for goods or services from various vendors.

14. The system of claim 3, further comprising filtering a subset of the vendor's offers for goods or services for display on the one or more intermediary websites or mobile apps.

15. The method of claim 1, further comprising allowing a participating intermediary entity to select which vendor offers to promote on their respective one or more intermediary websites or mobile apps.

16. The method of claim 1, further comprising:
allowing a participating vendor to select which participating intermediate entities may display their offers via the one or more intermediary websites or mobile apps, and
upon selection, automatically displaying the vendor offers on the respective one or more intermediary websites or mobile apps.

17. The method of claim 5, further comprising:
upon selection of a vendor's offer by a participating intermediary, automatically updating the vendor's website to display the participating intermediary as a donation candidate.

18. The method of claim 7, further comprising:
communicating the addition of a new vendor or a new intermediary to participating vendors or intermediary entities, and allowing the participating intermediary entities or vendors to add the new vendors or intermediaries to their respective apps or websites.

19. The method of claim 8, further comprising:
electronically communicating to the buyers' devices the addition of a new vendor offer or a new participating intermediary entity; and
directing the buyer to the newly added vendor offer or intermediary entity via one or more electronic links.

20. The method of claim 9, further comprising:
enabling electronic communication of a new vendor offer from one buyer's device to another buyer's device.
